(19) United States
(12) Patent Application Publication
(10) Pub. No.: US 2026/0299487 A1
(43) Pub. Date: Oct. 1, 2026

(54) RECORDING MEDIUM SUPPLY DEVICE AND IMAGE FORMING APPARATUS

(71) Applicant: FUJIFILM Business Innovation Corp., Tokyo (JP)

(72) Inventor: Yoshiki KIMURA, Kanagawa (JP)

(73) Assignee: FUJIFILM Business Innovation Corp., Tokyo (JP)

(21) Appl. No.: 19/309,624

(22) Filed: Aug. 26, 2025

(30) Foreign Application Priority Data
Mar. 26, 2025 (JP) 2025-052478

(51) Int. Cl. G03G 15/00; G06T 7/00

(52) U.S. Cl. CPC G03G 15/6511; G06T 7/0008; G03G 2215/00616; G03G 2215/00725; G06T 2207/30144

(57) ABSTRACT

A recording medium supply device includes: an accommodation portion that accommodates multiple stacked recording media; a restriction unit that comes into contact with a periphery of the recording media accommodated in the accommodation portion to restrict a position of the recording media; an auxiliary restriction unit that is attached to the accommodation portion and comes into contact with a periphery of a recording medium having a size smaller than the recording media restricted by the restriction unit to restrict a position of the recording medium; a blowing unit that blows air onto the periphery of the recording media accommodated in the accommodation portion; a detection unit that acquires optical information indicating a state inside the accommodation portion and detects a periphery of recording media floated by the air from the blowing unit; and a generation unit that uses the optical information acquired by the detection unit to generate information indicating a relationship between a presence or absence of attachment of the auxiliary restriction unit to the accommodation portion and a position of the detection unit in the accommodation portion.

### CROSS-REFERENCE TO RELATED APPLICATIONS

This application is based on and claims priority under 35 USC 119 from Japanese Patent Application No. 2025-052478 filed Mar. 26, 2025.

### BACKGROUND

### (i) Technical Field

The present invention relates to a recording medium supply device and an image forming apparatus.

### (ii) Related Art

JP2019-167197A discloses an image forming apparatus having a restriction plate that moves to a position corresponding to paper stored in a cassette body to restrict the position of the paper, and an auxiliary restriction member that is attached to the restriction plate to enable restriction of the position of small-sized paper.

### SUMMARY

In a recording medium supply device including a restriction unit that comes into contact with a recording medium accommodated in an accommodation portion to restrict a position of the recording medium, an auxiliary restriction unit may be attached to the accommodation portion in order to restrict the position of recording media that are smaller in size than the recording media that can be restricted by the restriction unit.

Furthermore, in the recording medium supply device, air may be blown onto the recording medium accommodated in the accommodation portion to float the recording medium, and the floating state of the recording medium may be detected by a detection unit. In order to improve the accuracy of detection by the detection unit, for example, it is preferable to dispose the detection unit at a predetermined position with respect to the recording medium. On the other hand, in a case in which the auxiliary restriction unit is attached to the accommodation portion, the detection unit deviates from a predetermined position unless the detection unit is moved.

Aspects of non-limiting embodiments of the present disclosure relate to a recording medium supply device and an image forming apparatus that dispose a detection unit at a predetermined position, compared to a case in which information regarding a relationship between the presence or absence of attachment of an auxiliary restriction unit and a position of the detection unit is not generated using optical information acquired by the detection unit.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a recording medium supply device including: an accommodation portion that accommodates a plurality of stacked recording media; a restriction unit that comes into contact with a periphery of the recording media accommodated in the accommodation portion to restrict a position of the recording media; an auxiliary restriction unit that is attached to the accommodation portion and comes into contact with a periphery of a recording medium having a size smaller than the recording media restricted by the restriction unit to restrict a position of the recording medium; a blowing unit that blows air onto the periphery of the recording media accommodated in the accommodation portion; a detection unit that acquires optical information indicating a state inside the accommodation portion and detects a periphery of recording media floated by the air from the blowing unit; and a generation unit that uses the optical information acquired by the detection unit to generate information indicating a relationship between a presence or absence of attachment of the auxiliary restriction unit to the accommodation portion and a position of the detection unit in the accommodation portion.

### BRIEF DESCRIPTION OF THE DRAWINGS

Exemplary embodiment(s) of the present invention will be described in detail based on the following figures, wherein:

FIG. 1 is a diagram showing an image forming apparatus to which the present exemplary embodiment is applied;

FIG. 2 is a diagram showing a configuration example of hardware of a control unit;

FIG. 3 is a schematic diagram for describing a configuration of a paper accommodating device, and is a cross-sectional view of III-III portion in FIG. 1;

FIG. 4 is a view of the paper accommodating device as viewed in a direction IV in FIG. 3;

FIG. 5 is a diagram showing the inside of the paper accommodating device;

FIG. 6 is a diagram showing the inside of the paper accommodating device;

FIG. 7 is a diagram showing a relationship between a restriction unit, an auxiliary restriction unit, and an imaging unit in a case in which the auxiliary restriction unit is attached;

FIGS. 8A and 8B are diagrams illustrating a relationship between the presence or absence of attachment of the auxiliary restriction unit and an image captured by the imaging unit;

FIGS. 9A and 9B are diagrams illustrating a relationship between the presence or absence of attachment of the auxiliary restriction unit and an image captured by the imaging unit;

FIGS. 10A and 10B are diagrams illustrating a relationship between the presence or absence of attachment of the auxiliary restriction unit and an image captured by the imaging unit;

FIGS. 11A and 11B are diagrams illustrating a relationship between the presence or absence of attachment of the auxiliary restriction unit and an image captured by the imaging unit;

FIG. 12 is a diagram illustrating a relationship between a restriction unit, an auxiliary restriction unit, and a CIS in a paper accommodating device according to Exemplary Embodiment 2;

FIGS. 13A and 13B are diagrams illustrating a relationship between the presence or absence of attachment of the auxiliary restriction unit and a position of the CIS; and

FIGS. 14A and 14B are diagrams illustrating a relationship between the presence or absence of attachment of the auxiliary restriction unit and a position of the CIS.

### DETAILED DESCRIPTION

Hereinafter, exemplary embodiments of the present invention will be described with reference to the accompanying drawings.

### Exemplary Embodiment 1

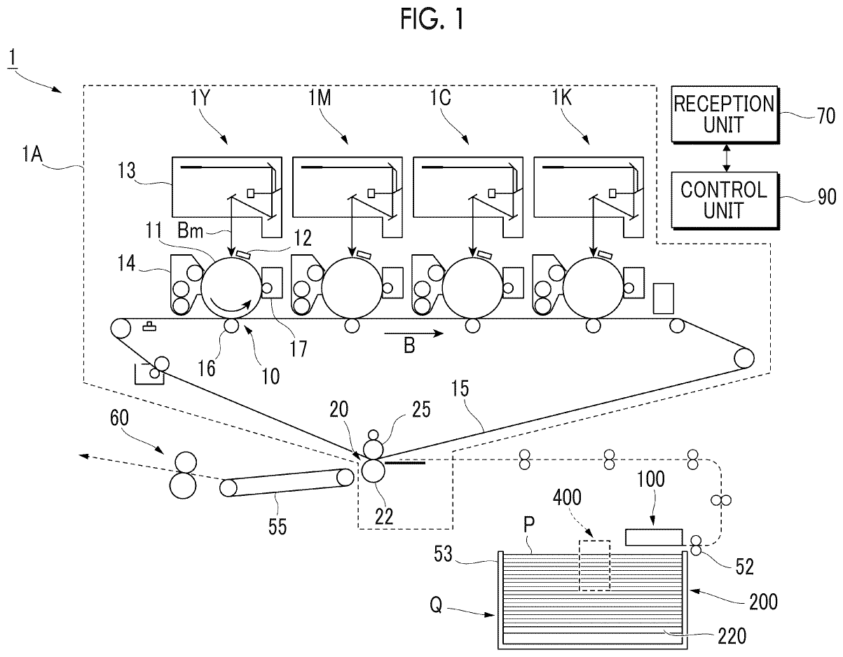

FIG. 1 is a diagram showing an image forming apparatus 1 to which the present exemplary embodiment is applied. In the following description, a direction from left to right in FIG. 1 is represented as an x direction, a direction from the front to the back of the page as a y direction, and a direction from bottom to top as a z direction.

The image forming apparatus 1 shown in FIG. 1 is an intermediate transfer type image forming apparatus 1 called a tandem type. The image forming apparatus 1 is provided with a paper accommodating device 200 that accommodates paper P which is an example of a recording medium.

Further, the image forming apparatus 1 is provided with an image forming section 1A. The image forming section 1A forms an image on the paper P sent out from the paper accommodating device 200.

The image forming section 1A is provided with a plurality of image forming units 1Y, 1M, 1C, and 1K. Each of the plurality of image forming units 1Y, 1M, 1C, and 1K uses an electrophotographic method to form a toner image of each color component.

In addition, the image forming section 1A is provided with a primary transfer unit 10. The toner images of the respective colors formed by the image forming units 1Y, 1M, 1C, and 1K are transferred onto an intermediate transfer belt 15 by the primary transfer unit 10.

In addition, the image forming section 1A is provided with a secondary transfer unit 20. The toner images transferred onto the intermediate transfer belt 15 are transferred onto the paper P by the secondary transfer unit 20.

In addition, the image forming apparatus 1 is also provided with a fixing device 60 that fixes, onto the paper P, the toner image secondarily transferred onto the paper P.

Further, the image forming apparatus 1 is provided with a control unit 90. In the present exemplary embodiment, a CPU provided in the control unit 90 processes information about the paper accommodating device 200. In the present exemplary embodiment, the control unit 90 and the paper accommodating device 200 constitute a recording medium supply device. The control unit 90 is an example of a generation unit.

The image forming apparatus 1 is further provided with a reception unit 70 that receives information input by a user.

The reception unit 70 is configured by, for example, a touch panel. The reception unit 70 has a reception function of receiving information from the user, as well as a display function of displaying the information.

A device for realizing the reception function and a device for realizing the display function may be individually provided.

### Configuration of Control Unit

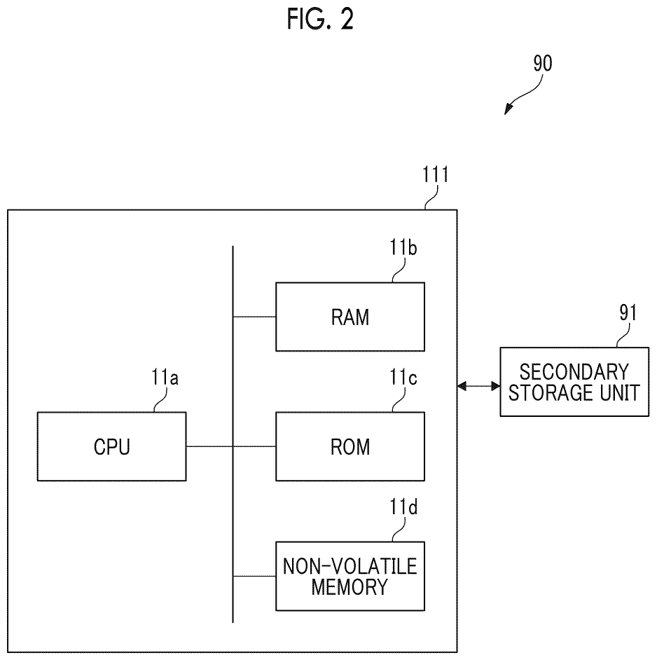

FIG. 2 is a diagram showing a hardware configuration example of the control unit 90. The control unit 90 is implemented by a computer.

The control unit 90 includes an arithmetic processing unit 111 that executes digital arithmetic processing according to a program, and a secondary storage unit 91 that stores information.

The secondary storage unit 91 is realized, for example, by a known information storage device such as a hard disk drive (HDD), a semiconductor memory, or a magnetic tape.

The arithmetic processing unit 111 is provided with a CPU 11a which is an example of a processor.

Further, the arithmetic processing unit 111 is provided with a RAM 11b that is used as a work memory or the like of the CPU 11a. Furthermore, the arithmetic processing unit 111 is provided with a ROM 11c in which a program and the like executed by the CPU 11a are stored.

The arithmetic processing unit 111 is also provided with a non-volatile memory 11d that can retain data even in a case in which power supply is interrupted.

The non-volatile memory 11d is configured by, for example, an SRAM or a flash memory that is backed up by a battery. The secondary storage unit 91 stores various types of information such as a program executed by the arithmetic processing unit 111.

In the present exemplary embodiment, the CPU 11a of the arithmetic processing unit 111 reads the program stored in the ROM 11c or the secondary storage unit 91. The CPU 11a executes the program stored in the ROM 11c or the secondary storage unit 91. Accordingly, various processes performed by the image forming apparatus 1 are executed. Various processes performed by the image forming apparatus 1 are executed by the CPU 11a.

The program executed by the CPU 11a can be provided to the image forming apparatus 1 via a recording medium.

Examples of the recording medium include a magnetic recording medium such as a magnetic tape or a magnetic disk. Examples of the recording medium also include an optical recording medium such as an optical disc.

Examples of the recording medium also include a magneto-optical recording medium. Examples of the recording medium also include a semiconductor memory.

Further, the program executed by the CPU 11a may be provided to the image forming apparatus 1 by using communication means such as the Internet.

The image forming apparatus 1 will be further described with reference to FIG. 1.

The following devices are installed in each of the image forming units 1Y, 1M, 1C, and 1K.

First, a photosensitive drum 11 that rotates in an arrow A direction is provided. A charging device 12 that charges the photosensitive drum 11 is provided around the photosensitive drum 11. In addition, an exposure device 13 that forms an electrostatic latent image on the photosensitive drum 11 is provided. Furthermore, a developing device 14 that develops the electrostatic latent image on the photosensitive drum 11 with a toner is provided.

Each of the image forming units 1Y, 1M, 1C, and 1K is provided with a primary transfer roll 16. The primary transfer roll 16 is provided at the primary transfer unit 10. The toner image formed on the photosensitive drum 11 is transferred onto the intermediate transfer belt 15 by the primary transfer roll 16.

Further, each of the image forming units 1Y, 1M, 1C, and 1K is provided with a drum cleaner 17. The drum cleaner 17 removes residual toner remaining on the photosensitive drum 11.

The intermediate transfer belt 15 circulates in an arrow B direction shown in FIG. 1 at a predetermined speed.

The primary transfer unit 10 includes the primary transfer rolls 16 that are disposed opposite the photosensitive drums 11 with the intermediate transfer belt 15 interposed therebetween.

In the present exemplary embodiment, the toner images on the photosensitive drums 11 are sequentially electrostatically attracted onto the intermediate transfer belt 15. Accordingly, a superimposed toner image is formed on the intermediate transfer belt 15.

The secondary transfer unit 20 includes a secondary transfer roll 22 and a backup roll 25 that are disposed opposite an outer peripheral surface of the intermediate transfer belt 15.

The secondary transfer roll 22 is pressed against the backup roll 25 with the intermediate transfer belt 15 interposed therebetween. A voltage is applied between the secondary transfer roll 22 and the backup roll 25. In the present exemplary embodiment, the toner images on the intermediate transfer belt 15 are transferred onto the paper P transported to the secondary transfer unit 20.

In the present exemplary embodiment, the paper P sent out from the paper accommodating device 200 is transported to the secondary transfer unit 20. The toner images on the intermediate transfer belt 15 are transferred onto the paper P sent out from the paper accommodating device 200.

In the present exemplary embodiment, image data is output to the image forming apparatus 1 from an image reading device (not shown) or a personal computer (PC) or the like.

Then, the image data is subjected to image processing by an image processing apparatus (not shown). Accordingly, image data for four colors Y, M, C, and K is generated. The generated image data is output to the exposure device 13 provided for each of the colors Y, M, C, and K.

The exposure device 13 irradiates the photosensitive drum 11 with light in accordance with input image data.

The exposure device 13 uses, for example, a semiconductor laser to expose the photosensitive drum 11. In addition, the exposure device 13 uses, for example, a light emitting diode (LED) to expose the photosensitive drum 11.

A surface of each photosensitive drum 11 is charged by the charging device 12. Thereafter, the surface is scanned and exposed by the exposure device 13, and an electrostatic latent image is formed on this surface.

Next, the toner is adhered to the photosensitive drum 11 by the developing device 14. Accordingly, toner images are formed on the photosensitive drums 11.

The toner images formed on the photosensitive drum 11 are transferred onto the intermediate transfer belt 15 in the primary transfer unit 10.

After the toner images are transferred onto a surface of the intermediate transfer belt 15, the toner images are moved to the secondary transfer unit 20 by the moving intermediate transfer belt 15.

In the secondary transfer unit 20, the secondary transfer roll 22 is pressed against the backup roll 25 via the intermediate transfer belt 15.

In the present exemplary embodiment, the paper P sent out from the paper accommodating device 200 is sandwiched between the intermediate transfer belt 15 and the secondary transfer roll 22.

Accordingly, an unfixed toner image held on the intermediate transfer belt 15 is transferred onto the paper P by the secondary transfer unit 20. Thereafter, the paper P onto which the toner image is transferred passes through the fixing device 60 and is discharged to a paper discharge unit (not shown).

### Description of Paper Accommodating Device

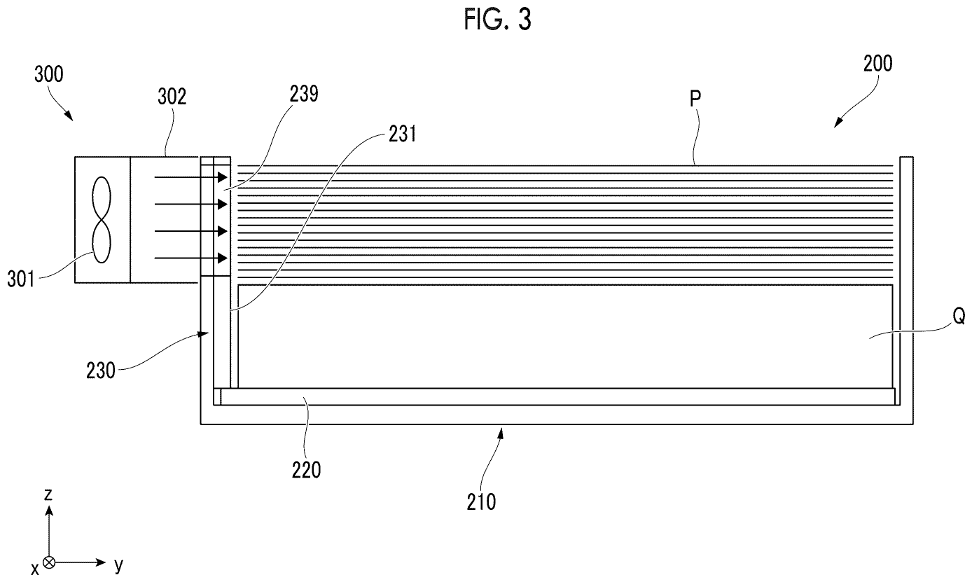

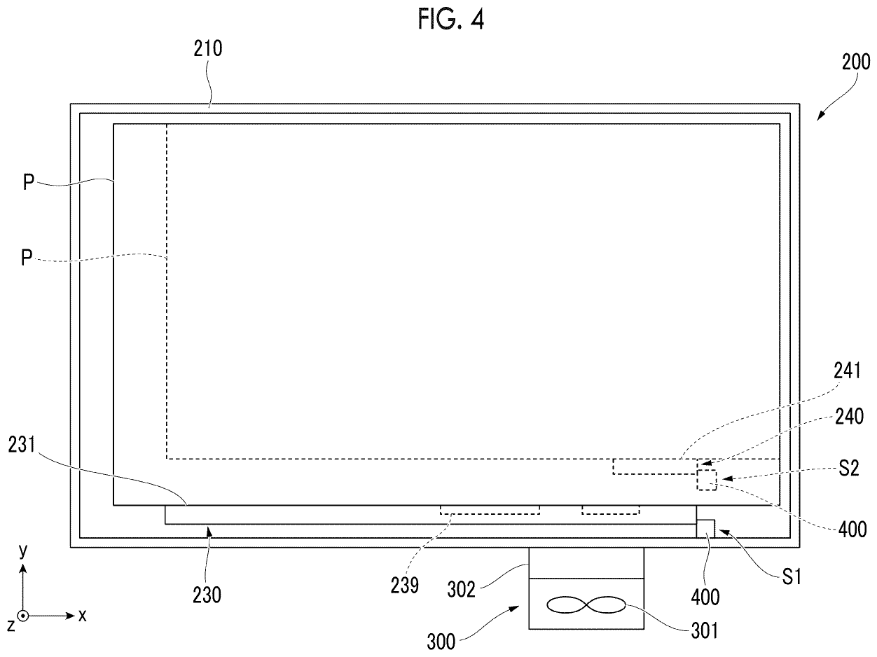

FIG. 3 is a schematic diagram for describing the configuration of the paper accommodating device 200, and is a cross-sectional view of III-III portion in FIG. 1. FIG. 4 is a view of the paper accommodating device 200 as viewed in a direction IV in FIG. 3.

The paper accommodating device 200 includes an accommodation portion 210 that accommodates a paper stack Q in which a plurality of sheets of paper P are stacked. The accommodation portion 210 is provided with a support stand 220 that supports the accommodated paper stack Q from below.

Further, above the paper stack Q accommodated in the paper accommodating device 200, there are provided a suction unit 100 (see FIG. 1) that sucks up and sends out the paper P constituting the paper stack Q, and a transport roll 52 that transports the paper P sent out by the suction unit 100 toward the image forming section 1A (see FIG. 1).

Furthermore, the paper accommodating device 200 may also be provided with a side guide (not shown) against which the periphery of the paper P constituting the paper stack Q abuts to restrict the position of the paper P in the accommodation portion 210.

The paper accommodating device 200 also includes a blowing unit 300 that blows air toward the periphery of the paper stack Q accommodated in the accommodation portion 210 to separate the paper P from the paper stack Q. In this example, the blowing unit 300 is provided on an upstream side in the y direction, that is, on the front side of the image forming apparatus 1 (see FIG. 1). The blowing unit 300 may be provided at the rear side of the image forming apparatus 1, or may be provided at both the front side and the rear side.

The blowing unit 300 includes, for example, an air blowing member 301 that blows out high-pressure air by rotating blades. In the present exemplary embodiment, the control unit 90 adjusts the air volume of air blown out from the air blowing member 301 based on an image captured by an imaging unit 400, which will be described later.

The air generated by the blowing unit 300 is blown against the periphery of the paper stack Q accommodated in the accommodation portion 210 via a duct 302 connected to the air blowing member 301 and an opening 239 formed in a restriction unit 230, which will be described later. In this example, the air generated by the blowing unit 300 is blown onto the edge of the periphery of the paper stack Q on the upstream side in the y direction.

Then, in a case in which air is blown onto the paper stack Q accommodated in the accommodation portion 210, a plurality of sheets of paper P on the upper side (downstream side in the z direction) among the sheets of the paper P that constitutes the paper stack Q are floated. Accordingly, the plurality of sheets of paper P on the upper side are separated from the paper stack Q.

In a case in which the sheets of paper P are separated from the paper stack Q by the air from the blowing unit 300, the uppermost paper P is sucked into the suction unit 100 and sent out from the paper accommodating device 200. The paper P sent out from the paper accommodating device 200 by the suction unit 100 is then transported toward the image forming section 1A by the transport roll 52, which are an example of a transport section.

The paper accommodating device 200 includes an imaging unit 400 that captures an image of the paper P floated from the paper stack Q by the blowing unit 300. The imaging unit 400 is an example of a detection unit. In this example, the imaging unit 400 is provided on the upstream side in the y direction, that is, on the front side of the image forming apparatus 1. Then, the imaging unit 400 captures an image of the inside of the paper accommodating device 200, on the downstream side in the y direction from the position where the imaging unit 400 is provided.

Similarly to the blowing unit 300, the imaging unit 400 may be provided at the rear side of the image forming apparatus 1, or may be provided at both the front side and the rear side.

The imaging unit 400 is a so-called camera. The imaging unit 400 is configured by, for example, charge coupled devices (CCDs) or a complementary metal oxide semiconductor (CMOS). As the imaging unit 400, a monochrome camera or a color camera may be used.

The imaging unit 400 images the inside of the accommodation portion 210 and outputs an image, which is an example of optical information. In addition, in a case in which the paper P is sent out by the paper accommodating device 200, the imaging unit 400 images the periphery of the paper P that is accommodated in the accommodation portion 210 and floated from the paper stack Q by the blowing unit 300. In this example, the imaging unit 400 captures an image of the edge of the periphery of the paper P floated from the paper stack Q on the upstream side in the y direction.

The paper accommodating device 200 also includes a restriction unit 230 that comes into contact with the periphery of the paper P accommodated in the accommodation portion 210 to restrict the position of the paper P. Furthermore, in a case of accommodating paper P having a size smaller than the size of paper P that can be restricted by the restriction unit 230 in the accommodation portion 210, the paper accommodating device 200 is configured to attach an auxiliary restriction unit 240 that comes into contact with the periphery of the paper P to restrict the position of the paper P.

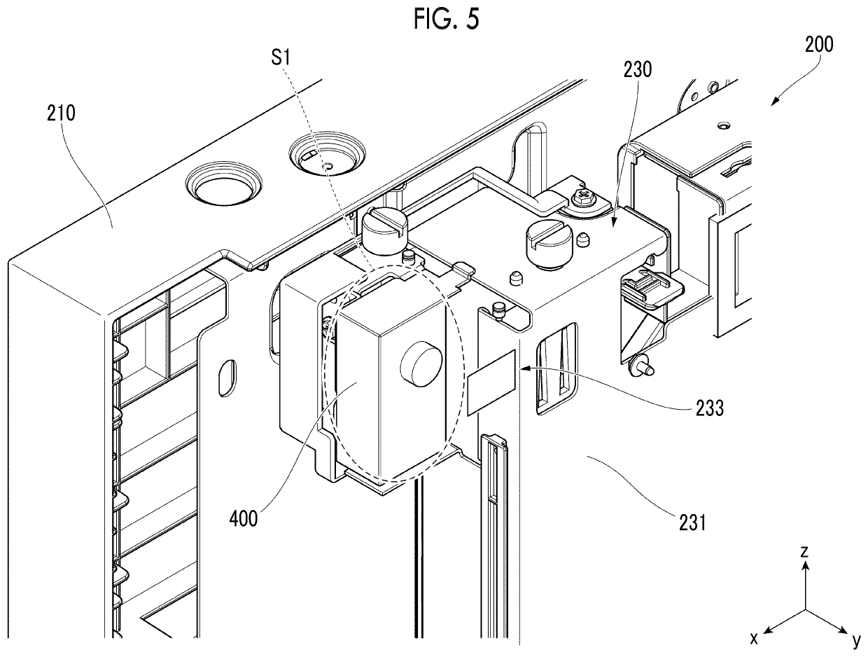

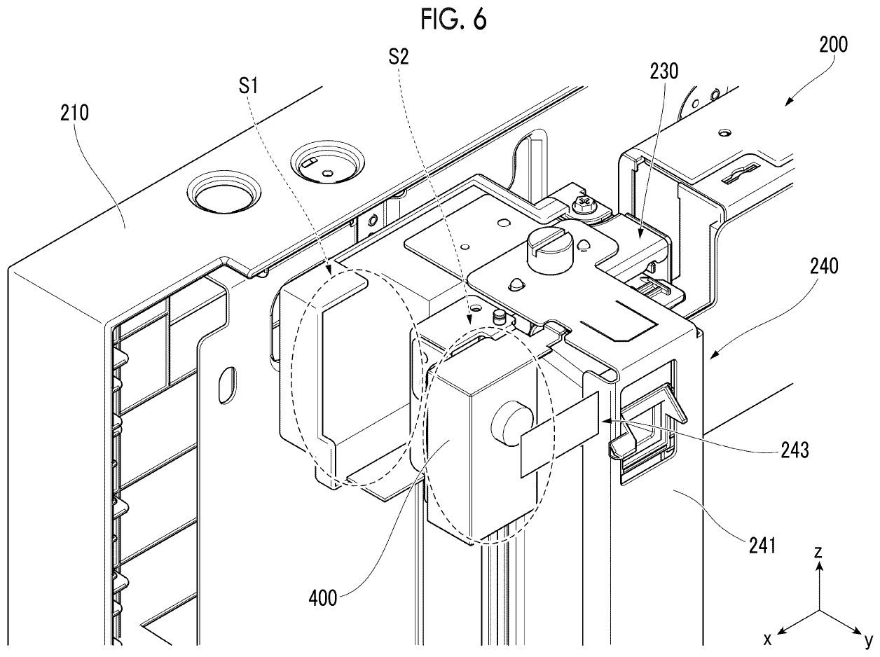

FIGS. 5 and 6 are diagrams showing the inside of the paper accommodating device 200. FIG. 5 shows the paper accommodating device 200 without the auxiliary restriction unit 240 attached, and FIG. 6 shows the paper accommodating device 200 with the auxiliary restriction unit 240 attached.

The restriction unit 230 is provided on the upstream side of the accommodation portion 210 in the y direction.

The restriction unit 230 has a wall surface 231 extending along the x direction and the z direction. The restriction unit 230 restricts the position of the paper P in the y direction by bringing the wall surface 231 into contact with the periphery of the paper P from the upstream side in the y direction.

The restriction unit 230 is configured to be movable in the y direction within a predetermined range according to the size of the paper P accommodated in the accommodation portion 210.

The auxiliary restriction unit 240 has a wall surface 241 extending along the x direction and the z direction. The auxiliary restriction unit 240 is attached to the accommodation portion 210 such that the wall surface 241 is located on the downstream side in the y direction from the wall surface 231 of the restriction unit 230. The auxiliary restriction unit 240 restricts the position in the y direction of paper P that is smaller than the size of paper P that can be restricted by the restriction unit 230 by bringing the wall surface 241 into contact with the periphery of the paper P from the upstream side in the y direction.

### Relationship Between Restriction Unit, Auxiliary Restriction Unit, and Imaging Unit

In the present exemplary embodiment, the control unit 90 adjusts the air volume of air blown by the blowing unit 300 using the image of the periphery of the paper P captured by the imaging unit 400. In addition, the control unit 90 detects the floating state of the paper P using the image of the periphery of the paper P captured by the imaging unit 400. The control unit 90 then adjusts the air volume of the air such that the floating state of the paper P is a predetermined state.

In order to accurately detect the floating state of the paper P, it is preferable that the periphery of the paper P is clearly captured by the imaging unit 400, for example. In the paper accommodating device 200 of the present exemplary embodiment, from the viewpoint of clearly capturing an image of the periphery of the paper P by the imaging unit 400, the position of the imaging unit 400 is configured to be changed depending on the presence or absence of attachment of the auxiliary restriction unit 240 to the accommodation portion 210.

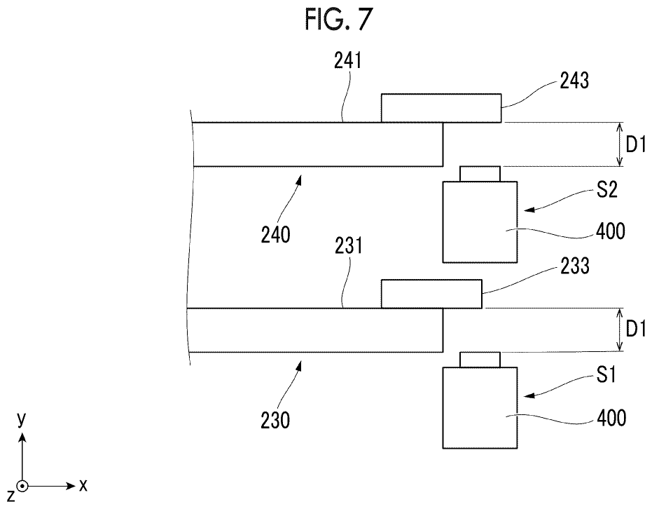

FIG. 7 is a diagram showing a relationship between the restriction unit 230, the auxiliary restriction unit 240, and the imaging unit 400 in a case in which the auxiliary restriction unit 240 is attached. FIG. 7 is a diagram showing the inside of the paper accommodating device 200 to which the auxiliary restriction unit 240 is attached, as viewed from the upstream side in the z direction.

In the paper accommodating device 200, in a case in which the auxiliary restriction unit 240 is not attached, the imaging unit 400 is attached at a first position S1 where the distance in the y direction from the wall surface 231 of the restriction unit 230 is a predetermined reference distance D1. The reference distance D1 is a distance at which, in a case in which the periphery of the paper P, which is at a distance of the reference distance D1 from the imaging unit 400, is imaged, an image that enables the floating state of the paper P to be detected can be acquired. The reference distance D1 is determined according to the focal length of the lens included in the imaging unit 400 or the like.

In addition, in the paper accommodating device 200, in a case in which the auxiliary restriction unit 240 is attached, the imaging unit 400 is attached at a second position S2 where the distance in the y direction from the wall surface 241 of the auxiliary restriction unit 240 is the reference distance D1.

In the paper accommodating device 200, the user may attach the imaging unit 400 to the first position S1 or the second position S2 depending on the presence or absence of attachment of the auxiliary restriction unit 240. In this case, depending on the presence or absence of attachment of the auxiliary restriction unit 240, the imaging unit 400 may be attached in an incorrect position. In a case in which the auxiliary restriction unit 240 is not attached, the first position S1 is the correct position for the imaging unit 400, and the second position S2 is the incorrect position for the imaging unit 400. Furthermore, in a case in which the auxiliary restriction unit 240 is attached, the second position S2 is the correct position for the imaging unit 400, and the first position S1 is the incorrect position for the imaging unit 400.

In a case in which the imaging unit 400 is in the incorrect position with respect to the presence or absence of attachment of the auxiliary restriction unit 240, the distance between the imaging unit 400 and the periphery of the paper P restricted by the restriction unit 230 or the auxiliary restriction unit 240 deviates from the reference distance D1.

In the present exemplary embodiment, the control unit 90 uses the image captured by the imaging unit 400 to acquire the relationship between the presence or absence of attachment of the auxiliary restriction unit 240 and the position of the imaging unit 400. Accordingly, the imaging unit 400 is suppressed from being attached at an incorrect position depending on the presence or absence of attachment of the auxiliary restriction unit 240.

The control unit 90 acquires the relationship between the presence or absence of attachment of the auxiliary restriction unit 240 and the position of the imaging unit 400 based on whether or not a first index 233 and a second index 243 are included in the image captured by the imaging unit 400.

The first index 233 is an example of an index, and is attached to the restriction unit 230. The first index 233 is a plate-like member extending along the x direction and the z direction. In this example, the first index 233 has a rectangular shape. The first index 233 is provided along the wall surface 231 of the restriction unit 230.

The first index 233 is provided within the range of imaging by the imaging unit 400. Moreover, it is preferable that the first index 233 is provided, for example, within the range of imaging by the imaging unit 400, but within a range that is not used for detecting the floating state of the paper P. In this example, the first index 233 is provided above (downstream side in the z direction) the range in which the paper P is floated by the air from the blowing unit 300. Accordingly, the periphery of the paper P that is floated by the air is suppressed from being blocked by the first index 233 in the image captured by the imaging unit 400.

The second index 243 is another example of an index, and is attached to the auxiliary restriction unit 240. The second index 243 is a plate-like member extending along the x direction and the z direction. In this example, the second index 243 has a rectangular shape. More specifically, the second index 243 has a rectangular shape whose length in the x direction is longer than the length of the first index 233. In addition, the second index 243 is provided along the wall surface 241 of the auxiliary restriction unit 240.

The second index 243, similarly to the first index 233, is provided within the range of imaging by the imaging unit 400. Moreover, it is preferable that the second index 243 is provided, for example, within the range of imaging by the imaging unit 400, but within a range that is not used for detecting the floating state of the paper P. In this example, the second index 243 is provided above (downstream side in the z direction) the range in which the paper P is floated by the air from the blowing unit 300. Accordingly, the periphery of the paper P that is floated by the air is suppressed from being blocked by the second index 243 in the image captured by the imaging unit 400.

In a state in which the auxiliary restriction unit 240 is attached, the second index 243 is provided on the downstream side of the first index 233 in the y direction.

More specifically, the first index 233 is provided on the downstream side in the y direction from the first position S1 of the imaging unit 400 and on the upstream side in the y direction from the second position S2.

The second index 243 is provided on the downstream side in the y direction from the second position S2 of the imaging unit 400.

The second index 243 is provided at a position where a portion of the area overlaps the first index 233 in the y direction. In addition, in a case of looking inside the accommodation portion 210 from the upstream side in the y direction in a state in which the imaging unit 400 is not attached, the first index 233 can be visually recognized, and the second index 243 that protrudes from the first index 233 can also be visually recognized. In this example, the portion of the second index 243 on the downstream side in the x direction protrudes from the first index 233 and can be visually recognized.

### Relationship Between Presence or Absence of Attachment of Auxiliary Restriction Unit and Image Captured by Imaging Unit

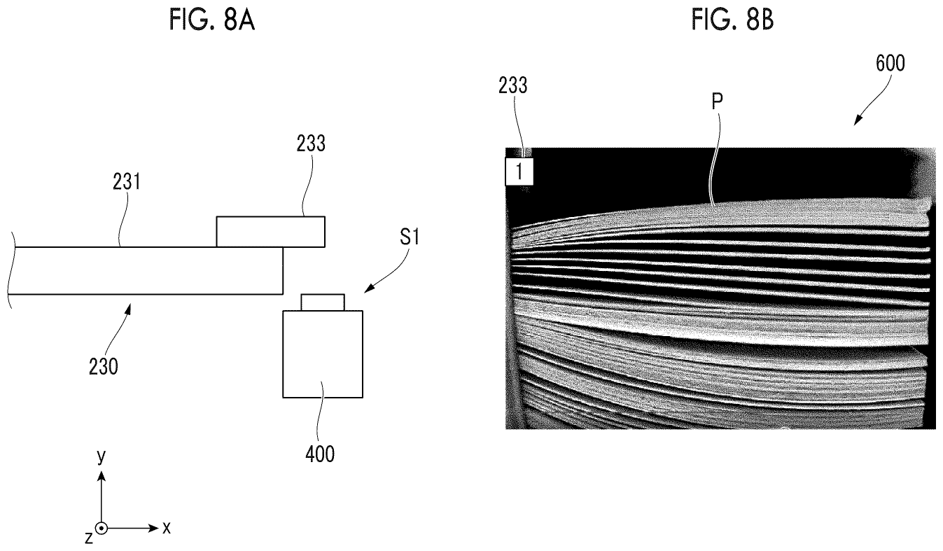

FIGS. 8A to 11B are diagrams illustrating the relationship between the presence or absence of attachment of the auxiliary restriction unit 240 (see FIG. 4) and an image 600 captured by the imaging unit 400. FIGS. 8A to 11A show the inside of the paper accommodating device 200 (see FIG. 3) as viewed from the upstream side in the z direction. FIGS. 8B to 11B show examples of an image 600 captured by the imaging unit 400.

FIGS. 8A and 8B show a case in which the auxiliary restriction unit 240 is not attached and the imaging unit 400 is attached at the first position S1 which is the correct position.

In a case in which the auxiliary restriction unit 240 is not attached and the imaging unit 400 is attached at the first position S1, the first index 233 is located on the downstream side of the imaging unit 400 in the y direction. Furthermore, since the auxiliary restriction unit 240 is not attached, the second index 243 (see FIG. 7) is not present inside the paper accommodating device 200.

Therefore, the image 600 captured by the imaging unit 400 includes the first index 233 but does not include the second index 243.

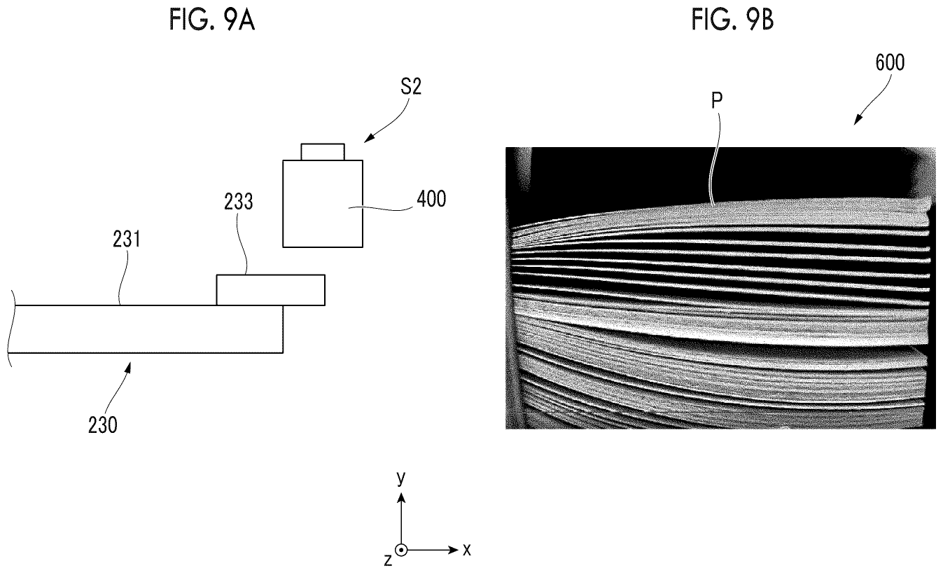

FIGS. 9A and 9B show a case in which the auxiliary restriction unit 240 is not attached and the imaging unit 400 is attached at the second position S2 which is an incorrect position.

In a case in which the auxiliary restriction unit 240 is not attached and the imaging unit 400 is attached at the second position S2, the first index 233 is located on the upstream side of the imaging unit 400 in the y direction. Furthermore, since the auxiliary restriction unit 240 is not attached, the second index 243 is not present inside the paper accommodating device 200.

Therefore, the image 600 captured by the imaging unit 400 does not include either the first index 233 or the second index 243.

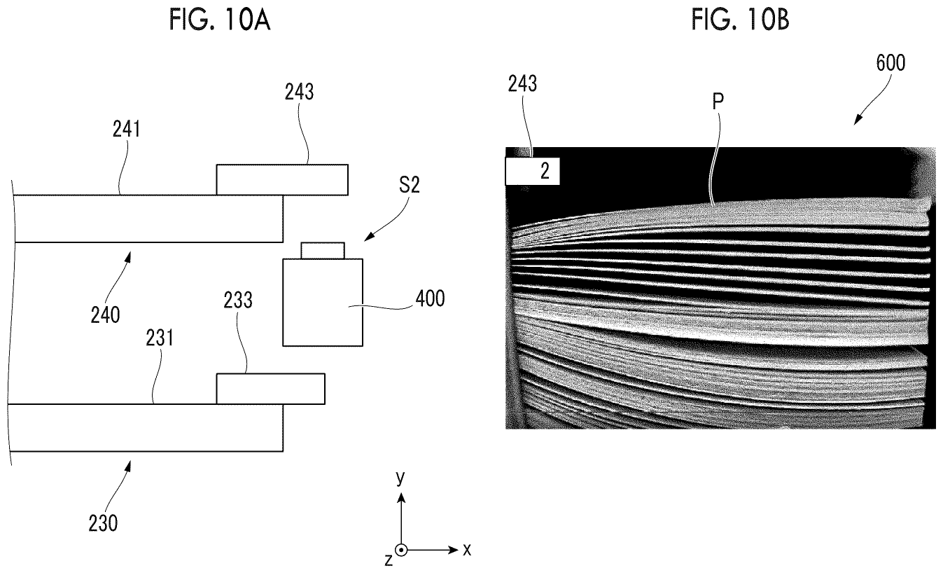

FIGS. 10A and 10B show a case in which the auxiliary restriction unit 240 is attached and the imaging unit 400 is attached at the second position S2 which is the correct position.

In a case in which the auxiliary restriction unit 240 is attached and the imaging unit 400 is attached at the second position S2, the first index 233 is located on the upstream side of the imaging unit 400 in the y direction, and the second index 243 is located on the downstream side of the imaging unit 400 in the y direction.

Therefore, the image 600 captured by the imaging unit 400 includes the second index 243 but does not include the first index 233.

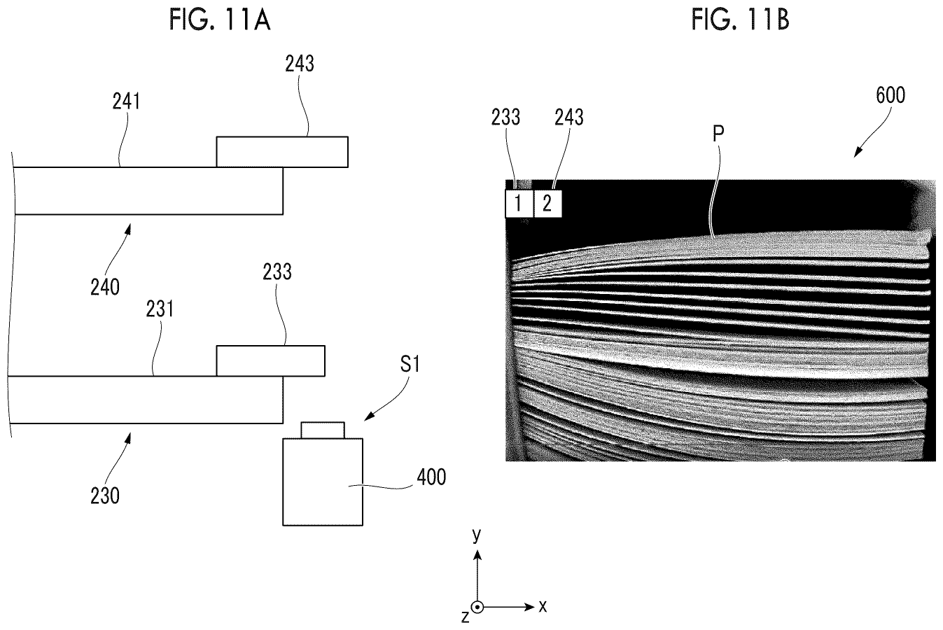

FIGS. 11A and 11B show a case in which the auxiliary restriction unit 240 is attached and the imaging unit 400 is attached at the first position S1 which is an incorrect position.

In a case in which the auxiliary restriction unit 240 is attached and the imaging unit 400 is attached at the first position S1, the first index 233 and the second index 243 are located on the downstream side of the imaging unit 400 in the y direction.

Therefore, the image 600 captured by the imaging unit 400 includes both the first index 233 and the second index 243.

### Processing by Control Unit

The control unit 90 of the present exemplary embodiment uses the image 600 captured by the imaging unit 400 to perform processing for generating information regarding the relationship between the presence or absence of attachment of the auxiliary restriction unit 240 and the position of the imaging unit 400.

The control unit 90 acquires the image 600 captured by the imaging unit 400. For example, in a case in which an image is formed on paper P by the image forming section 1A, the control unit 90 acquires the image 600 captured by the imaging unit 400 at the timing at which the paper P is accommodated in the paper accommodating device 200.

Then, the control unit 90 generates information indicating correctness or incorrectness of the position of the imaging unit 400 with respect to the presence or absence of attachment of the auxiliary restriction unit 240, based on whether or not the first index 233 and the second index 243 are included in the image 600.

In addition, the control unit 90 generates, as the information indicating correctness or incorrectness, information indicating whether or not the imaging unit 400 is in the first position S1 in a case in which the auxiliary restriction unit 240 is not attached. Furthermore, the control unit 90 generates, as the information indicating correctness or incorrectness, information indicating whether or not the imaging unit 400 is in the second position S2 in a case in which the auxiliary restriction unit 240 is attached.

In a case in which the image 600 includes the first index 233 but does not include the second index 243 (FIG. 8B), the control unit 90 generates information indicating that the position of the imaging unit 400 is correct. Furthermore, in a case in which the image 600 includes the second index 243 but does not include the first index 233 (FIG. 10B), the control unit 90 generates information indicating that the position of the imaging unit 400 is correct.

On the other hand, in a case in which neither the first index 233 nor the second index 243 is included in the image 600 (FIG. 9B), the control unit 90 generates information indicating that the position of the imaging unit 400 is incorrect. Furthermore, in a case in which both the first index 233 nor the second index 243 are included in the image 600 (FIG. 11B), the control unit 90 generates information indicating that the position of the imaging unit 400 is incorrect.

In a case in which the position of the imaging unit 400 is correct, the control unit 90 controls the paper accommodating device 200 to start the operation of sending out the paper P from the image forming section 1A.

On the other hand, in a case in which the position of the imaging unit 400 is incorrect, the control unit 90 controls the reception unit 70, which is an example of an output unit, to display information indicating that the position of the imaging unit 400 is incorrect. For example, the information indicating that the position of the imaging unit 400 is incorrect may include information indicating the correct position of the imaging unit 400 or information instructing the user to correct the imaging unit 400. In addition, the information indicating that the position of the imaging unit 400 is incorrect may include information indicating that the attachment or detachment of the auxiliary restriction unit 240 is to be instructed.

In addition, the control unit 90 of the present exemplary embodiment can detect whether the imaging unit 400 is attached at the first position S1 or the second position S2 based on whether or not the first index 233 is included in the image 600 captured by the imaging unit 400. That is, as shown in FIGS. 8A and 8B and FIGS. 11A and 11B, in a case in which the image 600 includes the first index 233, the imaging unit 400 is attached at the first position S1. Also, as shown in FIGS. 9A to 10B, in a case in which the image 600 does not include the first index 233, the imaging unit 400 is attached at the second position S2.

Furthermore, the control unit 90 can detect whether or not the auxiliary restriction unit 240 is attached based on whether or not the second index 243 is included in the image 600 captured by the imaging unit 400. That is, as shown in FIGS. 8A to 9B, in a case in which the image 600 does not include the second index 243, the auxiliary restriction unit 240 is not attached. Furthermore, as shown in FIGS. 10A to 11B, in a case in which the image 600 includes the second index 243, the auxiliary restriction unit 240 is attached.

As described above, in the present exemplary embodiment, the image 600 captured by the imaging unit 400 is used to generate information regarding the relationship between the presence or absence of attachment of the auxiliary restriction unit 240 and the position of the imaging unit 400. Accordingly, the imaging unit 400 is likely to be disposed at a predetermined correct position with respect to the presence or absence of attachment of the auxiliary restriction unit 240.

In addition, compared to a case in which a sensor or the like for acquiring the relationship between the presence or absence of attachment of the auxiliary restriction unit 240 and the position of the imaging unit 400 is provided separately from the imaging unit 400, the configuration of the paper accommodating device 200 and the image forming apparatus 1 is suppressed from becoming complicated.

### Exemplary Embodiment 2

Subsequently, Exemplary Embodiment 2 of the present invention will be described. The same reference numerals are used for the same configurations as in Exemplary Embodiment 1, and detailed description thereof will be omitted.

In the paper accommodating device 200 (see FIG. 1) of Exemplary Embodiment 1, the periphery of the floated paper P is detected using an image captured by the imaging unit 400, which is a so-called camera. The paper accommodating device 200 may detect the periphery of the floated paper P by a contact image sensor (CIS) 450 instead of the imaging unit 400.

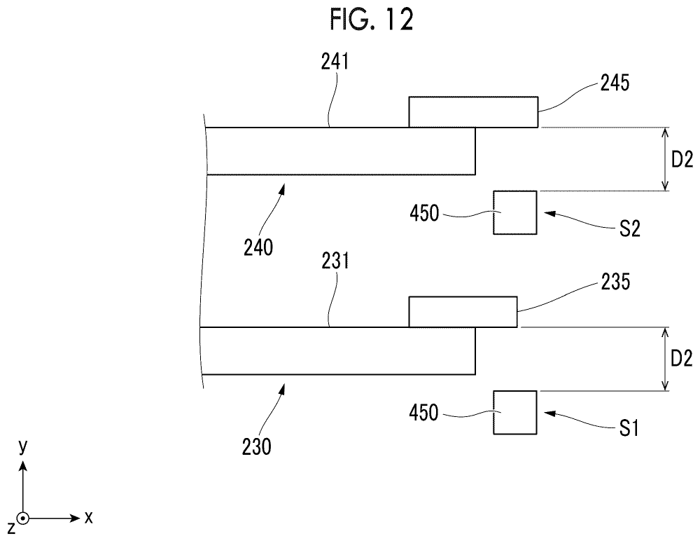

FIG. 12 is a diagram illustrating the relationship between a restriction unit 230, an auxiliary restriction unit 240, and a CIS 450 in the paper accommodating device 200 according to Exemplary Embodiment 2. FIG. 12 is a diagram showing the inside of the paper accommodating device 200 to which the auxiliary restriction unit 240 is attached, as viewed from the upstream side in the z direction.

The CIS 450 is configured such that a plurality of photoelectric conversion elements (not shown) are arranged in the z direction, which is the stacking direction of pieces of paper P (see FIG. 3) in the paper stack Q (see FIG. 3). The CIS 450 is an example of a detection unit.

The CIS 450 outputs an electrical signal in response to an object located within a predetermined range on the upstream side of the CIS 450 in the y direction. For example, the CIS 450 detects an object that is present at a position whose distance from the CIS 450 is at a predetermined reference distance D2, and outputs an electrical signal. Moreover, the CIS 450 does not detect an object that is present at a position whose distance from the CIS 450 is outside the reference distance D2.

The control unit 90 (see FIG. 1) of Exemplary Embodiment 2 detects the floating state of the paper P by using an electrical signal output by the CIS 450 detecting the periphery of the paper P. The electrical signal output from the CIS 450 is an example of optical information.

In the paper accommodating device 200, in a case in which the auxiliary restriction unit 240 is not attached, the CIS 450 is attached at a first position S1 where the distance in the y direction from the wall surface 231 of the restriction unit 230 is the reference distance D2.

In addition, in the paper accommodating device 200, in a case in which the auxiliary restriction unit 240 is attached, the CIS 450 is attached at a second position S2 where the distance in the y direction from the wall surface 241 of the auxiliary restriction unit 240 is the reference distance D2.

In a case in which the auxiliary restriction unit 240 is not attached, the first position S1 is the correct position for the CIS 450, and the second position S2 is the incorrect position for the CIS 450. Furthermore, in a case in which the auxiliary restriction unit 240 is attached, the second position S2 is the correct position for the CIS 450, and the first position S1 is the incorrect position for the CIS 450.

In Exemplary Embodiment 2, the control unit 90 acquires the relationship between the presence or absence of attachment of the auxiliary restriction unit 240 and the position of the CIS 450 based on whether or not the CIS 450 detects the first index 235 and the second index 245.

The first index 235 is an example of an index, and is provided inside the paper accommodating device 200. The first index 235 is a plate-like member extending along the x direction and the z direction. The first index 235 is provided along the wall surface 231 of the restriction unit 230.

The first index 235 is provided at a position that can be detected by the CIS 450 attached at the first position S1 in a case in which the auxiliary restriction unit 240 is not attached. Furthermore, in a case in which the auxiliary restriction unit 240 is attached, the first index 235 is stored in a housing (not shown) of the paper accommodating device 200 and is not exposed within a range that can be detected by the CIS 450.

The second index 245 is another example of an index, and is attached to the auxiliary restriction unit 240. The second index 245 is a plate-like member extending along the x direction and the z direction. The second index 245 is provided along the wall surface 241 of the auxiliary restriction unit 240.

The second index 245 is provided at a position that can be detected by the CIS 450 attached at the second position S2 in a case in which the auxiliary restriction unit 240 is attached.

The first index 235 and the second index 245 have unique shapes such that, in a case in which the first index 235 and the second index 245 are detected by the CIS 450, different electrical signals are output.

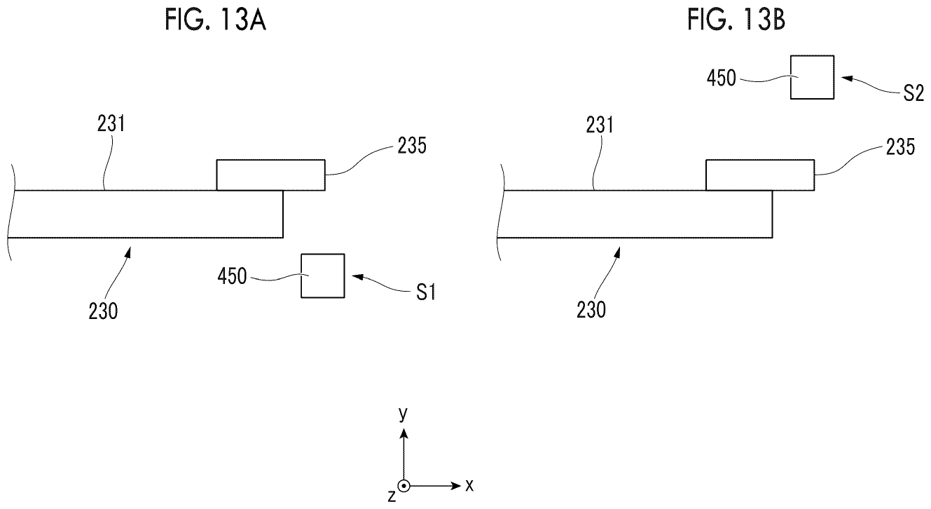

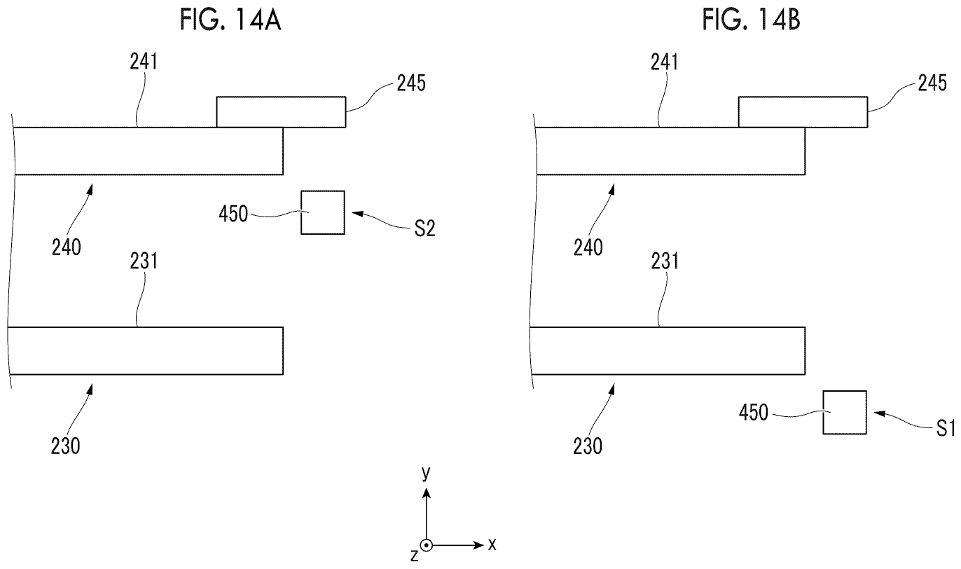

FIGS. 13A and 13B and FIGS. 14A and 14B are diagrams illustrating the relationship between the presence or absence of attachment of the auxiliary restriction unit 240 and the position of the CIS 450. FIGS. 13A and 13B and FIGS. 14A and 14B show the inside of the paper accommodating device 200 as viewed from the upstream side in the z direction.

FIG. 13A shows a case in which the auxiliary restriction unit 240 is not attached and the CIS 450 is attached at the first position S1 which is the correct position.

In a case in which the auxiliary restriction unit 240 is not attached and the CIS 450 is attached at the first position S1, the first index 235 is located on the downstream side of the CIS 450 in the y direction. The distance between the CIS 450 and the first index 235 is the reference distance D2 (see FIG. 12). Therefore, the CIS 450 detects the first index 235. In addition, since the auxiliary restriction unit 240 is not attached, the second index 245 is not present inside the paper accommodating device 200. Therefore, the CIS 450 does not detect the second index 245.

FIG. 13B shows a case in which the auxiliary restriction unit 240 is not attached and the CIS 450 is attached at the second position S2 which is an incorrect position.

In a case in which the auxiliary restriction unit 240 is not attached and the CIS 450 is attached at the second position S2, the first index 235 is located on the upstream side of the CIS 450 in the y direction. In addition, since the auxiliary restriction unit 240 is not attached, the second index 245 is not present inside the paper accommodating device 200. Therefore, the CIS 450 does not detect either the first index 235 or the second index 245.

FIG. 14A shows a case in which the auxiliary restriction unit 240 is attached and the CIS 450 is attached at the second position S2 which is the correct position.

In a case in which the auxiliary restriction unit 240 is attached and the CIS 450 is attached at the second position S2, the second index 245 is located on the downstream side of the CIS 450 in the y direction. The distance between the CIS 450 and the second index 245 is the reference distance D2 (see FIG. 12). Therefore, the CIS 450 detects the second index 245. Additionally, since the first index 235 is stored, the CIS 450 does not detect the first index 235.

FIG. 14B shows a case in which the auxiliary restriction unit 240 is attached and the CIS 450 is attached at the first position S1 which is an incorrect position.

In a case in which the auxiliary restriction unit 240 is attached and the CIS 450 is attached at the first position S1, the second index 245 is located on the downstream side of the CIS 450 in the y direction. The distance between the CIS 450 and the second index 245 is greater than the reference distance D2. In addition, the distance between the CIS 450 and the second index 245 exceeds the distance at which the second index 245 can be detected by the CIS 450. Further, the first index 235 is stored. Therefore, the CIS 450 does not detect either the first index 235 or the second index 245.

The control unit 90 acquires an electrical signal that is the detection result by the CIS 450. Then, based on the detection result by the CIS 450, the control unit 90 generates information indicating correctness or incorrectness of the position of the CIS 450 with respect to the presence or absence of attachment of the auxiliary restriction unit 240.

In other words, in a case in which the CIS 450 detects the first index 235, or in a case in which the CIS 450 detects the second index 245, the control unit 90 generates information indicating that the position of the CIS 450 is correct with respect to the presence or absence of attachment of the auxiliary restriction unit 240.

In addition, in a case in which the CIS 450 does not detect either the first index 235 or the second index 245, the control unit 90 generates information indicating that the position of the CIS 450 is incorrect with respect to the presence or absence of attachment of the auxiliary restriction unit 240.

In a case in which the position of the CIS 450 is correct, the control unit 90 controls the paper accommodating device 200 to start the operation of sending out the paper P from the image forming section 1A.

On the other hand, in a case in which the position of the CIS 450 is incorrect, the control unit 90 controls the reception unit 70 to display information indicating that the position of the CIS 450 is incorrect.

As described above, in the present exemplary embodiment, the detection result by the CIS 450 is used to generate information regarding the relationship between the presence or absence of attachment of the auxiliary restriction unit 240 and the position of the CIS 450. Accordingly, the CIS 450 is likely to be disposed at a predetermined correct position with respect to the presence or absence of attachment of the auxiliary restriction unit 240.

In addition, compared to a case in which a sensor or the like for acquiring the relationship between the presence or absence of attachment of the auxiliary restriction unit 240 and the position of the CIS 450 is provided separately from the CIS 450, the configuration of the paper accommodating device 200 and the image forming apparatus 1 is suppressed from becoming complicated.

Although the exemplary embodiments of the present invention have been described above, the technical scope of the present invention is not limited to the scope described in the above-described exemplary embodiments. It is apparent from claims that exemplary embodiments in which various modifications or improvements are added to the above-mentioned exemplary embodiments are also included in the technical scope of the present invention.

### Supplementary Note

### 1

A recording medium supply device comprising:
an accommodation portion that accommodates a plurality of stacked recording media;
a restriction unit that comes into contact with a periphery of the recording media accommodated in the accommodation portion to restrict a position of the recording media;
an auxiliary restriction unit that is attached to the accommodation portion and comes into contact with a periphery of a recording medium having a size smaller than the recording media restricted by the restriction unit to restrict a position of the recording medium;
a blowing unit that blows air onto the periphery of the recording media accommodated in the accommodation portion;
a detection unit that acquires optical information indicating a state inside the accommodation portion and detects a periphery of recording media floated by the air from the blowing unit; and
a generation unit that uses the optical information acquired by the detection unit to generate information indicating a relationship between a presence or absence of attachment of the auxiliary restriction unit to the accommodation portion and a position of the detection unit in the accommodation portion.

### 2

The recording medium supply device according to (((1))),
wherein the generation unit generates, as the information indicating the relationship, information indicating correctness or incorrectness of the position of the detection unit with respect to the presence or absence of attachment of the auxiliary restriction unit.

### 3

The recording medium supply device according to (((2))),
wherein the detection unit is movable between a first position where a distance from the restriction unit is a predetermined reference distance and a second position where a distance from the auxiliary restriction unit is the reference distance, and
the generation unit generates, as the information indicating correctness or incorrectness, information indicating whether or not the detection unit is at the first position in a case in which the auxiliary restriction unit is not attached, and information indicating whether or not the detection unit is at the second position in a case in which the auxiliary restriction unit is attached.

### 4

The recording medium supply device according to any one of (((1))) to (((3))),
wherein the detection unit is a camera that outputs an image captured inside the accommodation portion as the optical information, and
the generation unit generates the information indicating the relationship based on whether or not an index provided inside the accommodation portion is included in the image.

### 5

The recording medium supply device according to (((4))),
wherein a first index is provided in the restriction unit as the index, and
the generation unit recognizes the position of the detection unit in the accommodation portion based on whether or not the image includes the first index.

### 6

The recording medium supply device according to (((5))),
wherein a second index is provided in the auxiliary restriction unit as the index, and
the generation unit recognizes the presence or absence of attachment of the auxiliary restriction unit to the accommodation portion based on whether or not the image includes the second index.

### 7

The recording medium supply device according to (((6))),
wherein the generation unit generates information indicating that the position of the detection unit is correct with respect to the presence or absence of attachment of the auxiliary restriction unit in a case in which the image includes the first index and does not include the second index, and in a case in which the image does not include the first index and includes the second index, and generates information indicating that the position of the detection unit is incorrect with respect to the presence or absence of attachment of the auxiliary restriction unit in a case in which the image includes the first index and the second index, and in a case in which the image does not include the first index and the second index.

### 8

The recording medium supply device according to any one of (((1)) to (((3))),
wherein the detection unit is a contact image sensor in which a plurality of photoelectric conversion elements are arranged in a stacking direction of the recording media and that outputs an electrical signal detected within the accommodation portion as the optical information, and
the generation unit is provided within the accommodation portion and generates the information regarding the relationship based on a detection result by the detection unit between a first index that is stored in a case in which the auxiliary restriction unit is attached to the accommodation portion and a second index that is provided on the auxiliary restriction unit.

### 9

The recording medium supply device according to any one of (((1))) to (((8))),
wherein the generation unit generates the information regarding the relationship using the optical information acquired in a range not used for detecting the periphery of the recording media.

### 10

The recording medium supply device according to any one of (((1))) to (((9))), further comprising:
an output unit that outputs information indicating that the position of the detection unit is incorrect in a case in which the relationship between the presence or absence of attachment of the auxiliary restriction unit to the accommodation portion and the position of the detection unit in the accommodation portion differs from a predetermined reference.

### 11

An image forming apparatus comprising:
the recording medium supply device according to any one of (((1))) to (((10)));
a transport section that transports a recording medium floated by air in the recording medium supply device; and
an image forming section that forms an image on the recording medium transported by the transport section.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A recording medium supply device comprising:
an accommodation portion that accommodates a plurality of stacked recording media;
a restriction unit that comes into contact with a periphery of the recording media accommodated in the accommodation portion to restrict a position of the recording media;
an auxiliary restriction unit that is attached to the accommodation portion and comes into contact with a periphery of a recording medium having a size smaller than the recording media restricted by the restriction unit to restrict a position of the recording medium;
a blowing unit that blows air onto the periphery of the recording media accommodated in the accommodation portion;
a detection unit that acquires optical information indicating a state inside the accommodation portion and detects a periphery of recording media floated by the air from the blowing unit; and
a generation unit that uses the optical information acquired by the detection unit to generate information indicating a relationship between a presence or absence of attachment of the auxiliary restriction unit to the accommodation portion and a position of the detection unit in the accommodation portion.

2. The recording medium supply device according to claim 1,
wherein the generation unit generates, as the information indicating the relationship, information indicating correctness or incorrectness of the position of the detection unit with respect to the presence or absence of attachment of the auxiliary restriction unit.

3. The recording medium supply device according to claim 2,
wherein the detection unit is movable between a first position where a distance from the restriction unit is a predetermined reference distance and a second position where a distance from the auxiliary restriction unit is the reference distance, and
the generation unit generates, as the information indicating correctness or incorrectness, information indicating whether or not the detection unit is at the first position in a case in which the auxiliary restriction unit is not attached, and information indicating whether or not the detection unit is at the second position in a case in which the auxiliary restriction unit is attached.

4. The recording medium supply device according to claim 1,
wherein the detection unit is a camera that outputs an image captured inside the accommodation portion as the optical information, and
the generation unit generates the information indicating the relationship based on whether or not an index provided inside the accommodation portion is included in the image.

5. The recording medium supply device according to claim 4,
wherein a first index is provided in the restriction unit as the index, and
the generation unit recognizes the position of the detection unit in the accommodation portion based on whether or not the image includes the first index.

6. The recording medium supply device according to claim 5,
wherein a second index is provided in the auxiliary restriction unit as the index, and
the generation unit recognizes the presence or absence of attachment of the auxiliary restriction unit to the accommodation portion based on whether or not the image includes the second index.

7. The recording medium supply device according to claim 6,
wherein the generation unit generates information indicating that the position of the detection unit is correct with respect to the presence or absence of attachment of the auxiliary restriction unit in a case in which the image includes the first index and does not include the second index, and in a case in which the image does not include the first index and includes the second index, and generates information indicating that the position of the detection unit is incorrect with respect to the presence or absence of attachment of the auxiliary restriction unit in a case in which the image includes the first index and the second index, and in a case in which the image does not include the first index and the second index.

8. The recording medium supply device according to claim 1,
wherein the detection unit is a contact image sensor in which a plurality of photoelectric conversion elements are arranged in a stacking direction of the recording media and that outputs an electrical signal detected within the accommodation portion as the optical information, and
the generation unit is provided within the accommodation portion and generates the information regarding the relationship based on a detection result by the detection unit between a first index that is stored in a case in which the auxiliary restriction unit is attached to the accommodation portion and a second index that is provided on the auxiliary restriction unit.

9. The recording medium supply device according to claim 1,
wherein the generation unit generates the information regarding the relationship using the optical information acquired in a range not used for detecting the periphery of the recording media.

10. The recording medium supply device according to claim 1, further comprising:
an output unit that outputs information indicating that the position of the detection unit is incorrect in a case in which the relationship between the presence or absence of attachment of the auxiliary restriction unit to the accommodation portion and the position of the detection unit in the accommodation portion differs from a predetermined reference.

11. An image forming apparatus comprising:
the recording medium supply device according to claim 1;
a transport section that transports a recording medium floated by air in the recording medium supply device; and
an image forming section that forms an image on the recording medium transported by the transport section.

12. An image forming apparatus comprising:
the recording medium supply device according to claim 2;
a transport section that transports a recording medium floated by air in the recording medium supply device; and
an image forming section that forms an image on the recording medium transported by the transport section.

13. An image forming apparatus comprising:
the recording medium supply device according to claim 3;
a transport section that transports a recording medium floated by air in the recording medium supply device; and
an image forming section that forms an image on the recording medium transported by the transport section.

14. An image forming apparatus comprising:
the recording medium supply device according to claim 4;
a transport section that transports a recording medium floated by air in the recording medium supply device; and
an image forming section that forms an image on the recording medium transported by the transport section.

15. An image forming apparatus comprising:
the recording medium supply device according to claim 5;
a transport section that transports a recording medium floated by air in the recording medium supply device; and
an image forming section that forms an image on the recording medium transported by the transport section.

16. An image forming apparatus comprising:
the recording medium supply device according to claim 6;
a transport section that transports a recording medium floated by air in the recording medium supply device; and
an image forming section that forms an image on the recording medium transported by the transport section.

17. An image forming apparatus comprising:
the recording medium supply device according to claim 7;
a transport section that transports a recording medium floated by air in the recording medium supply device; and
an image forming section that forms an image on the recording medium transported by the transport section.

18. An image forming apparatus comprising:
the recording medium supply device according to claim 8;
a transport section that transports a recording medium floated by air in the recording medium supply device; and
an image forming section that forms an image on the recording medium transported by the transport section.

19. An image forming apparatus comprising:
the recording medium supply device according to claim 9;
a transport section that transports a recording medium floated by air in the recording medium supply device; and
an image forming section that forms an image on the recording medium transported by the transport section.

20. An image forming apparatus comprising:
the recording medium supply device according to claim 10;
a transport section that transports a recording medium floated by air in the recording medium supply device; and
an image forming section that forms an image on the recording medium transported by the transport section.
